(19) United States
(12) Patent Application Publication
(10) Pub. No.: US 2011/0038643 A1
(43) Pub. Date: Feb. 17, 2011

(54) IMAGE FORMING APPARATUS AND METHOD FOR ACQUIRING MAINTENANCE INFORMATION OF THE SAME

(75) Inventor: Koji Yamaki, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/852,784

(22) Filed: Aug. 9, 2010

Related U.S. Application Data
(60) Provisional application No. 61/232,918, filed on Aug. 11, 2009.

(51) Int. Cl. G03G 15/00

(52) U.S. Cl. 399/8; 399/88

(57) ABSTRACT

Certain embodiments provide an image forming apparatus including: a print processing unit; a fixing unit; a first storage unit to store use frequency information of respective parts forming the print processing unit and the fixing unit and failure information; a wireless transmission unit; and a controller. The configured allows the wireless transmission unit to transmit maintenance information to a wireless terminal positioning within an area to which the wireless transmission unit transmits a wireless signal.

### CROSS-REFERENCE TO RELATED APPLICATION

The present application claims priority under 35 U.S.C. 119 to U.S. Provisional Application Ser. No. 61/232,918, entitled LOCAL MAINTENANCE SYSTEM OF IMAGE FORMING APPARATUS, to YAMAKI, filed on Aug. 11, 2009, the entire disclosure of which is incorporated herein by reference.

### FIELD

An embodiment described herein relates generally to an image forming apparatus and a method for acquiring maintenance information of the same.

### BACKGROUND

An image forming apparatus such as an MFP (Multi Function Peripheral) has consumable goods. The consumable goods need to be maintained. An MFP Maintenance staff member exchanges, supplements, and cleans parts of the MFP.

In general, the maintenance staff member regularly visits customer's offices or stores. The maintenance staff member checks the use situation and problem of the MFPs.

The MFP forms an image on a sheet. The MFP increases a counter of sheet numbers or the like.

In recent years, a technique is known for acquiring use frequency information such as a counter value via a network.

For example, software is known for managing the MFPs and printers in an integrated way.

At a remote location, however, a maintenance terminal may not acquire the use frequency information from the MFP which is not connected to a network.

In small-scale offices, the MFPs may not be connected to an external network of the offices in many cases. The MFPs are isolated from a maintenance host server and a maintenance terminal.

The maintenance staff member needs to directly visit the offices or stores. The maintenance staff member needs to insert a USB (Universal Serial Bus) memory into the MFPs to directly collect the use frequency information.

While the number of the types of MFPs increases and the types diversify, the number of maintenance staff members is limited. In addition, one maintenance staff member has to be in charge of a broad range. The resources of the maintenance staff are insufficient in regard to the number of MFPs.

Each maintenance staff member has to take charge of numerous MFPs on the market. All maintenance staff members have difficult tasks to check all MFPs in charge of the members.

The maintenance staff member visits offices one by one. The maintenance staff member visits the offices by car. Whenever visiting the offices, the maintenance staff member stops the car in the front of the offices or the buildings and carry their equipment.

If there is no problem in the checked MFPs, the maintenance staff member just cleans a plurality of units in the MFPs and return. The maintenance staff member visits the next offices.

Since the maintenance staff member visits the offices in person and perform the maintenance, the maintenance staff members are obliged to bear the burden.

### BRIEF DESCRIPTION OF THE DRAWINGS

FIG. 1 is a diagram illustrating the configuration of an information transmission system including an image forming apparatus according to an embodiment;

FIG. 2 is a block diagram illustrating a wireless transmission unit of the image forming apparatus according to the embodiment;

FIG. 3 is a block diagram illustrating a wireless terminal;

FIG. 4 is a diagram illustrating the configuration of the image forming apparatus according to the embodiment;

FIG. 5 is a block diagram illustrating a control system of the image forming apparatus according to the embodiment;

FIG. 6 is a flowchart illustrating a method for transmitting maintenance information to a wireless terminal;

FIG. 7 is a diagram illustrating an example of a scan method by the wireless terminal;

FIGS. 8A and 8B are diagrams illustrating display examples of the wireless terminal; and

FIGS. 9A to 9C are diagrams illustrating other display examples of the wireless terminal.

### DETAILED DESCRIPTION

Certain embodiments provide an image forming apparatus including: a print processing unit configured to generate a developer image on a medium by an electrophotography; a fixing unit configured to fix the developer image on the medium; a first storage unit configured to store use frequency information of respective parts forming the print processing unit and the fixing unit and failure information of the image forming apparatus; a wireless transmission unit configured to transmit wirelessly maintenance information including the use frequency information or the failure information; and a controller configured to allow the wireless transmission unit to transmit the maintenance information to a wireless terminal positioning within an area to which the wireless transmission unit is operable to transmit a wireless signal.

Hereinafter, an image forming apparatus and a method for manufacturing the same according to an embodiment will be described in detail with reference to the accompanying drawings. Like numbers reference like elements in the drawings, and the repetition description is omitted.

### EMBODIMENT

An image forming apparatus according to an embodiment is an MFP including a wireless access point device. The MFP also has a short-range wireless communication function.

A method for acquiring maintenance information of the image forming apparatus according to the embodiment is a method of directly acquiring the maintenance information from the MFP by a wireless terminal carried by a maintenance staff member.

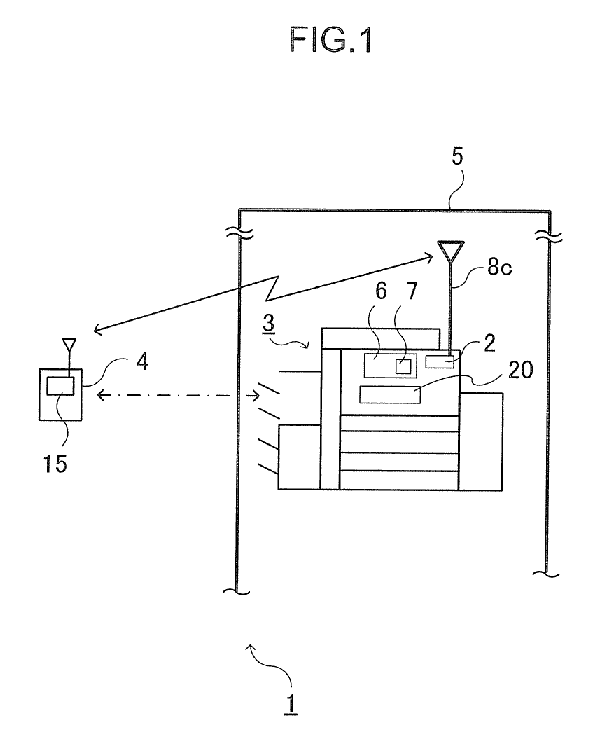

FIG. 1 is a diagram illustrating the configuration of an information transmission system including the MFP.

An information transmission system 1 includes an MFP 3 with an attached wireless access point device 2 (a wireless transmission unit), and a wireless terminal 4 transmitting and receiving a wireless signal to and from the wireless access point device 2.

The wireless access point device 2 has a wireless access point function. The MFP 3 has the wireless access point device 2 therein.

The MFP 3 is maintained by the maintenance staff member. The MFP 3 is located in any of the floors of Building 5.

The wireless terminal 4 is a maintenance terminal carried by the maintenance staff member. The maintenance staff member is a serviceman.

The wireless terminal 4 is located outside Building 5. For example, the wireless terminal 4 is located inside a car or between Building 5 and another building.

Alternatively, the wireless terminal 4 is located inside a room. For example, the wireless terminal 4 is located on the stairs in Building 5 or in the entrance floor of Building 5.

The MFP 3 is located in a room of any of the floors of Building 5. The wireless access point device 2 has transmission power. The transmission power has sufficient size so that the wireless terminal 4 can receive radio waves from the wireless access point device 2.

The wireless terminal 4 wirelessly collects the maintenance information from the MFP 3 via the wireless access point device 2.

The maintenance information includes use frequency information such as an operation situation or a use situation of the MFP 3 and failure information of the MFP 3.

The use frequency information refers to each operation situation of a plurality of units, a use situation of an application program of a control unit, a residual amount of toner, life information of a photoconductive drum, and a counter value of the number of sheets printed for each sheet size.

The failure information refers to jamming occurrence, toner of a print processing unit 20 running out, and log of occurrence of service calls or the like.

A wireless interface of a wireless service area uses a scheme regulated in, for example, IEEE 802.11x. The wireless terminal 4 and the wireless access point device 2 are connected to each other via a wireless LAN (Local Area Network).

The MFP 3 includes a main controller 6 (controller), the print processing unit 20, a fixing unit 33, a sheet transport mechanism 40, and a first storage unit 7.

The main controller 6 is a control unit which controls the entire MFP 3. The main controller 6 generates the maintenance information of the MFP 3.

The print processing unit 20 generates a toner image (developer image) on a sheet (medium) using an electrophotographic method.

The fixing unit 33 fixes the toner image on the sheet.

The sheet transport mechanism 40 supplies a sheet to the print processing unit 20 and transports the sheet from the fixing unit 33.

The first storage unit 7 stores the use frequency information and the failure information of the respective parts of the print processing unit 20, the fixing unit 33, and the sheet transport mechanism 40. For example, the first storage unit 7 stores the number of sheets printed, the number of times by which a motor is driven, jamming occurrence, and the like.

The main controller 6 writes and reads data in and from the first storage unit 7. The main controller 6 writes the maintenance information in the first storage unit 7.

The wireless access point device 2 is a wireless transmission unit having unique identification information. The wireless access point device 2 uses a device ID (Identification) of the wireless access point device 2 as the unique identification information.

The control unit 11 allows the wireless transmission unit 8a to transmit the maintenance information to the wireless terminal 4 positioning within an area. The wireless transmission unit 8a transmits a wireless signal. A direct signal wave or a reflected signal wave propagates from the wireless terminal 4 to the area.

The wireless access point device 2 wirelessly transmits the device ID of the wireless access point device 2 and the maintenance information.

The wireless terminal 4 is located within an area which can be reached by a wireless signal transmitted by the wireless access point device 2.

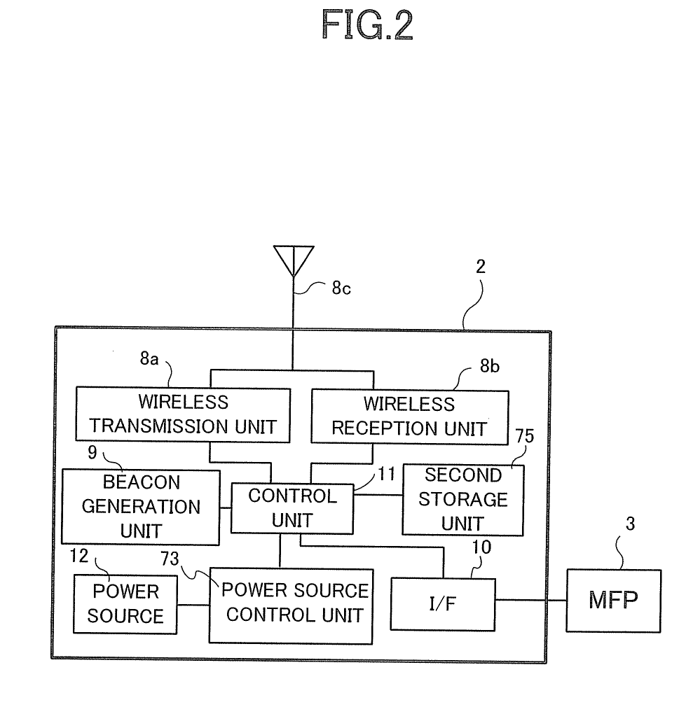

FIG. 2 is a block diagram illustrating the wireless access point device 2. The above-described reference numbers denote the same constituent elements.

The wireless access point device 2 includes an interface unit (I/F) 10, a second storage unit 75, a wireless transmission unit 8a, a wireless reception unit 8b, a beacon generation unit 9, a control unit 11, a power source 12 (second power source unit), and a power source control unit 73.

The interface unit 10 transmits data in a wired way to the main controller 6 of the MFP 3.

The second storage unit 75 stores the maintenance information, the terminal ID of the wireless terminal 4, a communication log of the maintenance information and the like. For example, the second storage unit 75 is a non-volatile memory.

The interface unit 10 receives the maintenance information stored by the first storage unit 7 of the MFP 3 side. The control unit 11 writes the maintenance information received by the interface unit 10 in the second storage unit 75.

The wireless transmission unit 8a transmits information data to the wireless terminal 4 via an antenna 8c. The wireless transmission unit 8a wirelessly transmits the maintenance information.

The device ID (device identification information) specifies the wireless access point device 2.

Alternatively, the device ID may directly specify the MFP 3. The wireless terminal 4 creates a table in advance which associates the MFP 3 and the wireless access point device 2.

If the device ID specifies the MFP 3, the wireless terminal 4 performs conversion with reference to the table and specifies the wireless access point device 2.

The wireless reception unit 8b wirelessly receives a transmission request from the wireless terminal 4.

The beacon generation unit 9 periodically inputs beacon data to the wireless transmission unit 8a. The beacon generation unit 9 adds an identifier to the beacon data. The identifier refers to a service setting identification address (service set identifier).

The control unit 11 controls the entire wireless access point device 2.

The control unit 11 converts between the data format of the interface unit 10 side and the data format of the wireless transmission unit 8a side. The control unit 11 converts between the data format of the interface unit 10 side and the data format of the wireless reception unit 8b side.

The power source 12 supplies power to each unit of the wireless access point device 2. The power source 12 continues to supply power to the wireless reception unit 8b and the interface unit 10.

The power source control unit 73 switches ON and OFF of the power source 12.

The power source control unit 73 turns on the wireless access point device 2 in response to a request from the wireless terminal 4 or in response to a request from the main controller 6 of the MFP 3. The terminal ID of the wireless terminal 4 is stored in the second storage unit 75. For example, the terminal ID of the wireless terminal 4 from a control panel 41 of the MFP 3 is registered.

The wireless reception unit 8b receives an activation request from the wireless terminal 4. The control unit 11 extracts the terminal ID of the wireless terminal 4 from the activation request message. The control unit 11 authenticates with reference to the terminal ID transmitted from the wireless terminal 4 and the terminal ID registered in the second storage unit 75.

The authentication succeeds. Then, the power source control unit 73 activates the wireless access point device 2. The authentication fails. Then, the power source control unit 73 keeps the wireless access point device 2 in an OFF state.

The power source control unit 73 receives an activation request via the interface unit 10 and the control unit 11 in order to reply to the request from the MFP 3.

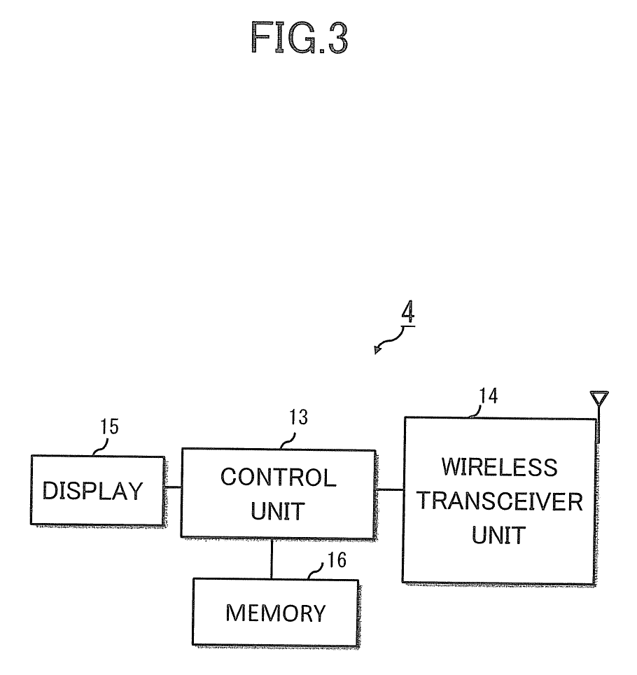

FIG. 3 is a block diagram illustrating the wireless terminal 4. The above-described reference numbers denote the same constituent elements. The wireless terminal 4 includes a control unit 13, a wireless transceiver unit 14, and a memory 16.

A maintenance application program is installed in the memory 16. The application program displays the maintenance information received from the wireless access point device 2 on a display 15.

The memory 16 stores the terminal ID of the wireless terminal 4.

The wireless transceiver unit 14 transmits and receives wireless signals. The wireless transceiver unit 14 has a short-range wireless communication function.

The wireless transceiver unit 14 uses, for example, Bluetooth (registered trademark) or ZIGBEE (registered trademark) as a short-range wireless interface. The wireless transceiver unit 14 may use a PHS (Personal Handy-phone System) as the wireless interface.

The wireless transceiver unit 14 has a function of transmitting and receiving a wireless signal based on the scheme regulated in IEEE 802.11x, for example.

The wireless transceiver unit 14 wirelessly transmits the activation request including the terminal ID based on the short-range wireless protocol. The wireless transceiver unit 14 wirelessly transmits an access request including the terminal ID by the IEEE 802.11x protocol.

The wireless terminal 4 and the wireless access point device 2 encode the wireless signals. For example, WPA (Wi-Fi protected Access) is used as an encoding scheme. The control unit 11 of the wireless access point device 2 side may encode the maintenance information and the terminal ID before modulation.

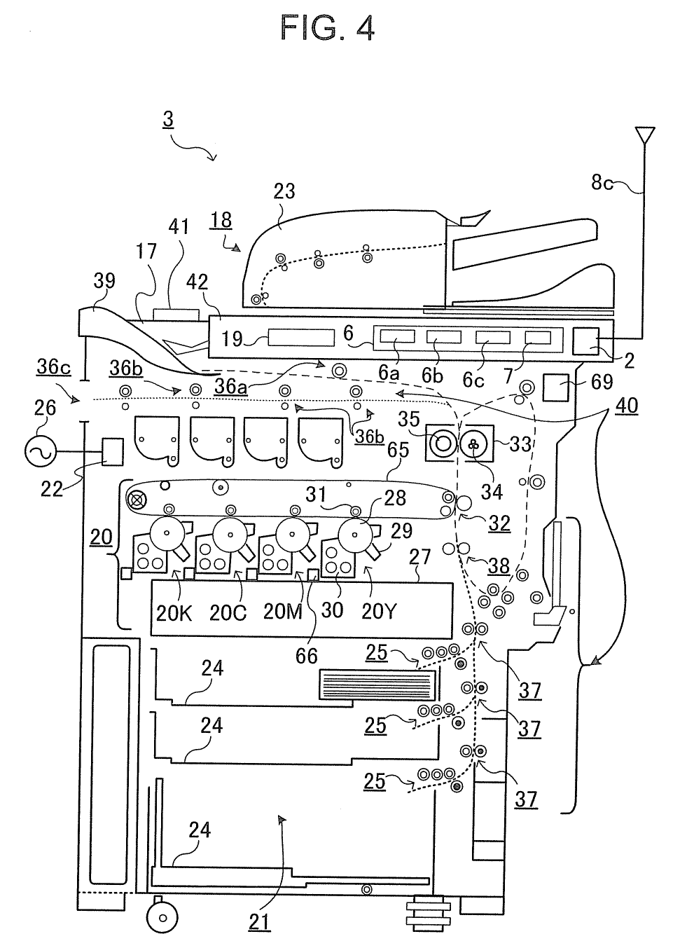

FIG. 4 is a diagram illustrating the configuration of the MFP 3. The above-described reference numbers denote the same constituent elements.

The MFP 3 includes the main controller 6, the first storage unit 7, an apparatus body 17, a scanner 18, an image processing unit 19, the print processing unit 20, a sheet feed unit 21, and a power source unit 22 (first power source unit).

The main controller 6 includes a main CPU (Central Processing Unit) 6a, a ROM (Read-Only Memory) 6b, and a RAM (Random Access Memory) 6c. As the first storage unit 7, for example, a hard disk drive is used.

The MFP 3 has the control panel 41 in an upper portion of the apparatus body 17.

The scanner 18 includes an automatic document feeder 23 and an optical system 42. The automatic document feeder 23 feeds an original document into the optical system 42. The optical system 42 scans the original document and outputs read image information.

The image processing unit 19 is an LSI (Large Scale Integration) which converts three-color image data from the scanner 18 into image data of four print colors.

The print processing unit 20 modulates four-color laser rays based on the four-color print data. The print processing unit 20 forms a toner image on a sheet.

The sheet feed unit 21 feeds a sheet to the print processing unit 20. The sheet feed unit 21 includes a plurality of cassettes 24 in a lower portion of the apparatus body 17. The MFP 3 has a plurality of pairs of rollers 25 in the inlets of the cassettes 24.

The power source unit 22 is the first power source unit. The power source unit 22 converts the power from a commercial alternating current power 26 into plural direct current voltage with different levels. The power source unit 22 turns the power supply to the MFP 3 on or off.

The print processing unit 20 will be described in more detail.

The printing processing unit 20 includes a yellow (Y) image forming unit 20Y, a magenta (M) image forming unit 20M, a cyan (C) image forming unit 20C, a black (K) image forming unit 20K, a laser exposure device 27, and a belt 65.

In the image forming unit 20Y, a photoconductive drum 28, a charging member 29, a development member 30, and a transfer member 31 are provided.

The photoconductive drum 28 retains a latent image on a photoconductive member.

The charging member 29 uniformly charges the photoconductive member on the photoconductive drum 28.

The laser exposure device 27 forms the latent image on the photoconductive drum 28.

The development member 30 develops the latent image on the photoconductive drum 28. The charging member 30 includes a development roller and a mixer.

The transfer member 31 includes a primary transfer roller. The primary transfer roller of the transfer member 31 transfers a toner image on the photoconductive drums 28 to the belt 65. The belt 65 is an intermediate transfer belt.

The image forming units 20M, 20C, and 20K have substantially the same configuration as that of the image forming unit 20Y.

The MFP 3 further includes a secondary transfer member 32 and the fixing unit 33. The secondary transfer member 32 includes one pair of rollers.

The MFP 3 includes the fixing unit 33 on the downstream side in a transport direction of the sheet.

The fixing unit 33 includes a heat roller 34 and a press roller 35.

The MFP 3 includes plural pairs of rollers 36a. The plural pairs of rollers 36a transport the sheet to a sheet discharging tray 39. The MFP 3 includes plural pairs of rollers 36b. The plural pairs of rollers 36b send the sheet to an opening 36c of the apparatus body 17.

The MFP 3 includes plural pairs of rollers 37 in the lower portion of the apparatus body 17. Each pair of rollers 37 separates one sheet and transports the sheet.

The MFP 3 includes a pair of rollers 38 above the pairs of rollers 37. The pair of rollers 38 corrects the skew of the sheet. The pair of rollers 38 guides the sheet to the print processing unit 20.

The nips of the pairs of rollers 25, 37, and 38, the guide member, the secondary transfer member 32, the fixing unit 33 define a transport path of the sheet.

Plural motors, the pairs of rollers in the secondary transfer member 32, the heat roller 34, the press roller 35, and the guide member form the sheet transport mechanism 40. The plural motors rotate the pairs of rollers 25, 37, and 38.

The main controller 6 detects the insertion of the original document into the scanner 18. The main controller 6 generates a print job. The main controller 6 drives the print processing unit 20.

The sheet transport mechanism 40 picks up the sheet from any one of the cassettes 24. The sheet transport mechanism 40 supplies the sheet to the transport path. The sheet transport mechanism 40 transports the sheet along the transport path from the lower side to the upper side.

Based on the image data generated by the scanner 18, the print processing unit 20 forms the latent image on the four photoconductive drums 28. Each development member 30 churns each color toner. Each development member 30 supplies toner to each photoconductive drum 28. The latent image is visualized.

The primary transfer roller of each transfer member 31 is located opposite each photoconductive drum 28 and the belt 65 at a distance. Each transfer member 31 charges each primary transfer roller.

The four-color toner image is moved on the belt surface of the belt 65. The secondary transfer member 32 transfers the color toner image obtained in this way onto the sheet.

The fixing unit 33 heats and presses the sheet. The fixing unit 33 fixes the four-color toner image on the sheet.

The pair of rollers 36a transport the sheet from the fixing unit 33 along the transport path on the upper side of the apparatus body 17. The sheet discharging tray 39 collects sheets in the sheet discharging tray 39.

The sheet from the fixing unit 33 is transported to the opening 36c by the pair of rollers 36b.

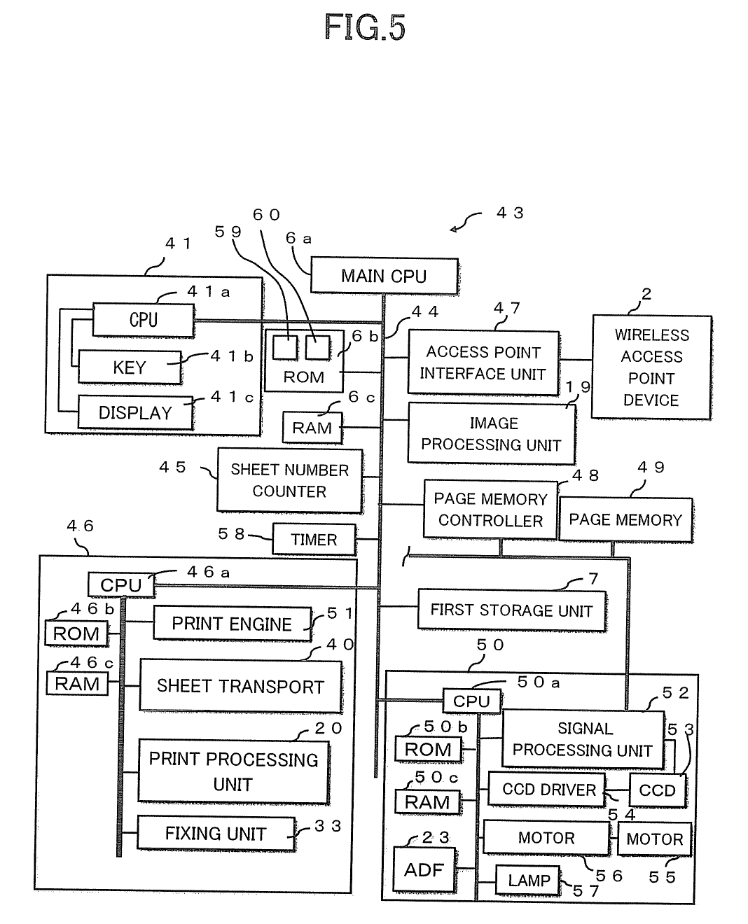

FIG. 5 is a block diagram illustrating a control system of the MFP 3. The above-described reference numbers denote the same constituent elements.

A control system 43 includes the main CPU 6a, the ROM 6b, the RAM 6c, the first storage unit 7, the image processing unit 19, a bus 44, the controller panel 41, a sheet number counter 45, and a timer 58.

The control system 43 includes a print control system 46 and an access point interface unit 47. The control system 43 further includes a page memory controller 48, a page memory 49, and a scanner control system 50.

The main CPU 6a generates the maintenance information. The main CPU 6a adds the device ID of the MFP 3 to the maintenance information. The main CPU 6a performs buffering of a packet including the maintenance information obtained in this way.

The RAM 6c stores the use frequency information and the failure information.

The ROM 6b stores a program 59. The program 59 causes the main CPU 6a to collect the use frequency information. The program 59 causes the main CPU 6a to generate a packet. The ROM 6b also stores reference activation time information 60.

The control panel 41 includes a CPU 41a, a key 41b, and a display 41c.

The sheet number counter 45 counts the number of sheets fed from each cassette 24. The main CPU 6a performs time stamps of the events corresponding to the events which occur and values of the timer 58.

The print control system 46 controls printing. The print control system 46 includes a CPU 46a, a ROM 46b, a RAM 46c, a print engine 51, the sheet transport mechanism 40, the print processing unit 20, and the fixing unit 33.

The print engine 51 has the laser exposure device 27 and a driver for the laser exposure device 27.

The access point interface unit 47 reads the maintenance information generated by the main CPU 6a from the RAM 6c and sends the maintenance information to the wireless access point device 2.

The page memory controller 48 controls access to the image data stored in the page memory 49. The image processing unit 19 or a signal processing unit 52 performs writing and reading in and from the page memory 49.

The scanner control system 50 controls scanning of an original document.

The scanner control system 50 includes a CPU 50a, a ROM 50b, a RAM 50c, the automatic document feeder 23, the signal processing unit 52, and a CCD (Charge Coupled Device) 53. The CCD 53, a carriage, a mirror, and a motor form the optical system 42.

The signal processing unit 52 processes signals output from the CCD 53, and supplies the data obtained in this way to the page memory 49.

The scanner control system 50 includes a CCD driver 54 controlling the CCD 53. The scanner control system 50 further includes a motor 55 driving the carriage, a motor driver 56 controlling the motor 55, and a lamp 57 for illumination.

The main CPU 6a communicates with the CPU 41a of the control panel 41. The main CPU 6a communicates with the CPU 46a of the print control system 46. The main CPU 6a communicates with the CPU 50a of the scanner control system 50.

The above-described MFP 3 is turned on in response to the operation through the control panel 41.

(1) If the wireless access point device 2 is turned on, the main CPU 6a turns on the power source unit 22 of the MFP 3.

The main CPU 6a transmits a control signal to the wireless access point device 2 via the access point interference unit 47. The control unit 11 and the power source control unit 73 of the wireless access point device 2 turn on the power source 12. The wireless access point device 2 is activated.

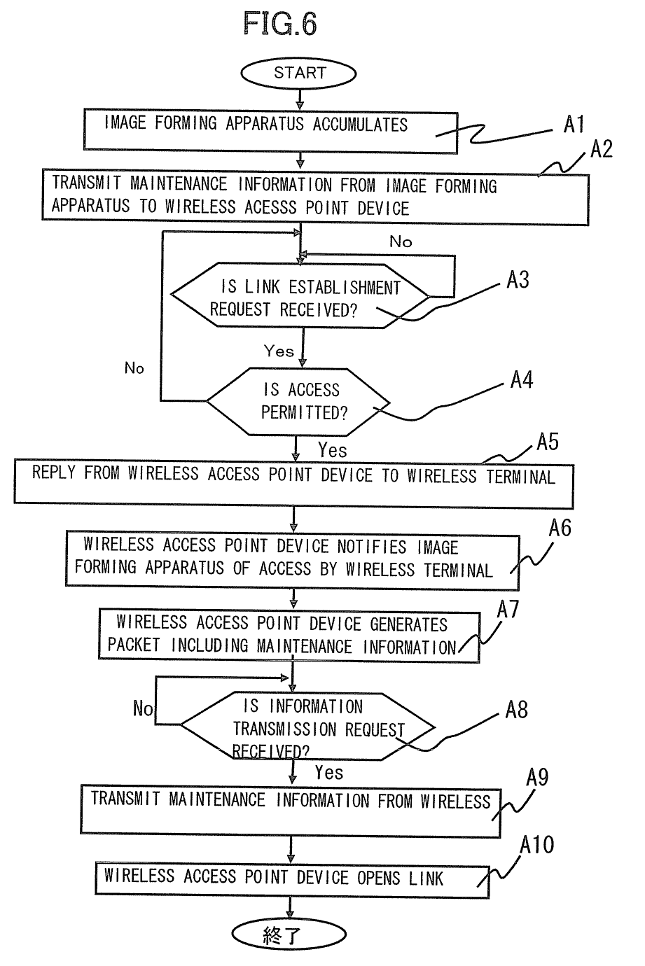

FIG. 6 is a flowchart illustrating a method for transmitting the maintenance information to the wireless terminal 4. The method is executed by cooperation of the MFP 3 and the wireless access point device 2.

The MFP 3 generates a print job. In Act A1, the main controller 6 of the MFP 3 (image forming apparatus) accumulates the maintenance information.

The print processing unit 20 has consumable goods. The maintenance staff member keeps monitoring the consumable goods.

The photoconductive drum 28 or a cleaner is used up. The degree that the consumable goods are used up depends on the colors. The grid and wire of the charging member 29 are used up.

The amount of toner of the development member 30 decreases. The toner flies around the development member 30. The box of the toner keeps being recovered. The first transfer roller, blade, brush of the transfer member 31 are used up.

Ozone is generated by the charge of the charging member 29 or the transfer member 31. The print processing unit 20 of the MFP 3 includes an ozone filter 66. The ozone filter 66 is also used up.

The fixing unit 33 has consumable goods. The heat roller 34 and the press roller 35 are used under a high temperature and a strong magnetic field.

Each roller in the sheet transport mechanism 40 keeps being rotated. The force from a transmission mechanism is repeatedly applied to and released from each roller.

Whenever the print job is generated, the control panel 41 notifies the main CPU 6a of input sheet size information. The control panel 41 notifies the main CPU 6a of input sheet number information and input sheet type information.

The print control system 46 receives input information from the main CPU 6a. The print processing unit 20 prints the sheet and outputs the sheet. The CPU 46a notifies the main CPU 6a of the sheet size information, the sheet number information, and the sheet type information of the sheet.

The main CPU 6a writes the sheet size information, the sheet number information, and the sheet type information in the sheet number counter 45.

The MFP 3 repeats the execution of the printing. The sheet number counter 45 accumulates the number of times of printing for each sheet size. The sheet number counter 45 accumulates the number of times of printing for each sheet type. The sheet number counter 45 accumulates the number of times of printing for each color.

The program 59 reads the counter value of the sheet number counter 45 as a number of printed sheets. The program 59 calculates a total activation time using the timer 58. The program 59 reads the reference activation time information 60 of the ROM 6b as life information.

The program 59 reads previous exchange date information and next scheduled exchange date of respective consumable goods from the RAM 6c. The program 59 generates the use frequency information of the respective consumable goods based on the respective information in the first storage unit 7.

The first storage unit 7 stores the following items as the use frequency information: the number of sheets, the reference number of sheets, a total activation time at the present time, a reference activation time, a sign indicating that the total activation time reaches the reference activation time, a date when the consumable goods are exchanged and a scheduled exchange date.

The main CPU 6a adds the failure information to the maintenance information in addition to the use frequency information.

The sheet transport mechanism 40 allows a sheet sensor to detect the jamming of the sheet. The CPU 46a transmits the location where and time stamp if the jamming occurs to the main CPU 6a. The main CPU 6a generates failure information such as jamming, errors, alarms, and the like in the first storage unit 7.

The control system 43 has a plurality of application programs to be driven. The main CPU 6a also writes the type and the time stamps of the application programs in the first storage unit 7.

In Act A2, the main CPU 6a allows the access point interface unit 47 to transmit the maintenance information in the first storage unit 7 to the wireless access point device 2.

The maintenance information is transmitted if the MFP 3 is turned off or if the wireless access point device 2 is turned off.

In Act A3, the MFP 3 monitors whether the wireless reception unit 8b received a link establishment request from the wireless terminal 4 or not. The main CPU 6a monitors whether interruption from the access point interface unit 47 occurs.

The main CPU 6a waits for a reception interruption via the No route, while the wireless reception unit 8b does not receive the link establishment request.

The wireless access point device 2 periodically transmits a beacon. The wireless access point device 2 continues the receiving.

Next, a scanning method by the wireless terminal 4 will be described.

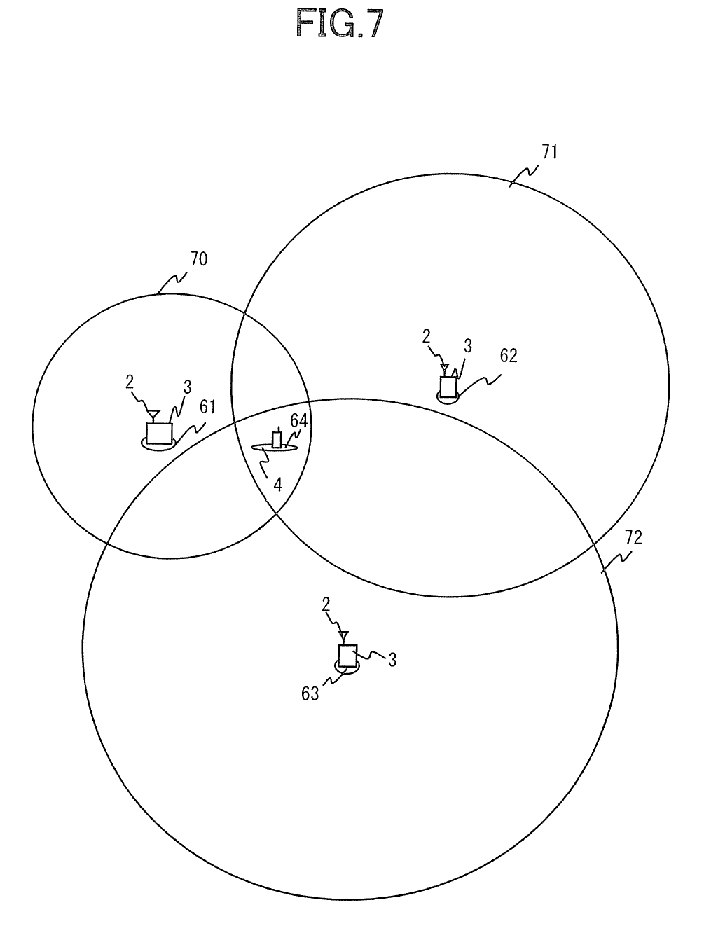

FIG. 7 is a diagram illustrating an example of the scanning method by the wireless terminal 4. The above-described reference numbers denote the same constituent elements.

The maintenance staff member maintains the plurality of MFPs 3 in an area for which he/her is in charge. For example, the wireless terminal 4 scans the identifiers of three wireless access point devices 2.

A first MFP 3 positions at a position 61. The position 61 indicates a room on the fifth floor of an office building. A second MFP 3 is a located at a position 62. The position 62 indicates the first floor of a store. A third MFP 3 is located at a position 63. The position 63 indicates the first floor of a factory.

Zones 70, 71 and 72 indicate the ranges which are reached by the radio waves from each wireless access point device 2.

The identifiers of the three wireless access point devices 2 are different from each other. The wireless terminal 4 stores the respective identifiers in advance.

The transmission power of the radio waves from the wireless access point device 2 has the strength that the radio waves reach the outdoor wireless terminal 4. For example, the wireless access point device 2 has the transmission power that the radio waves reach a range of hundreds of meters around an antenna 8c.

The maintenance staff member operates the wireless terminal 4 in a car on the road. In regard to a position 64, the wireless terminal 4 can directly communicate with the respective wireless access point devices 2 in the office building, the store, and the factory.

The wireless terminal 4 receives the beacons transmitted from the respective wireless access point devices 2. The wireless terminal 4 extracts the identifiers included in the beacons.

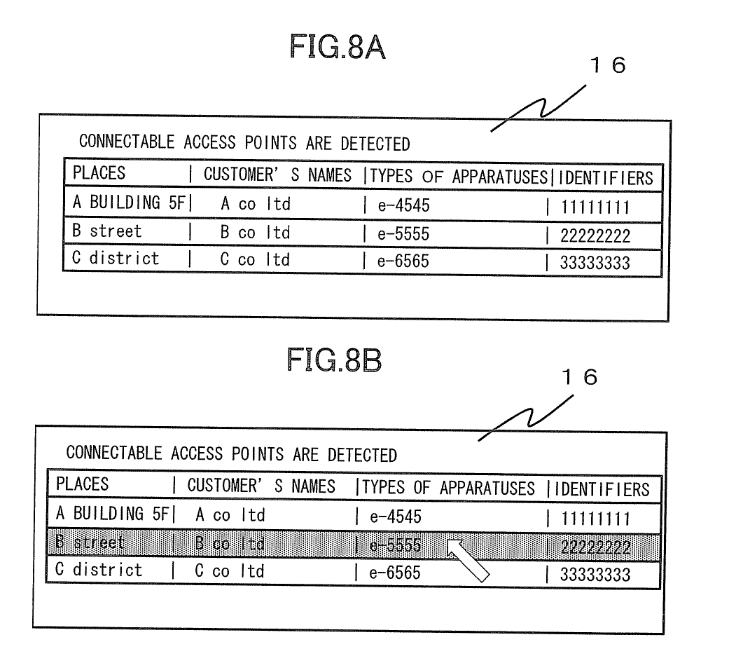

FIGS. 8A and 8B are diagrams illustrating display examples of the wireless terminal 4. The above-described reference numbers denote the same constituent elements. As shown in FIG. 8A, the wireless terminal 4 displays three wireless access point devices 2 on the display 15.

As shown in FIG. 8B, the user operates the wireless terminal 4 to select one of the wireless access point device 2.

The wireless terminal 4 wirelessly transmits, for example, a link establishment request including the device ID of the wireless access point device 2 at the position 62 and the terminal ID of the wireless terminal 4.

The wireless reception unit 8b receives the link establishment request.

In Act A4 of FIG. 6, the wireless access point device 2 determines whether access is permitted. The control unit 11 authenticates the wireless terminal 4 using the device ID of the wireless access point device 2, the received terminal ID, and the registered terminal ID in a link establishment request message.

In Act A4, the control unit 11 determines that the access is permitted. In Act A5, via the Yes route, the control unit 11 transmits a response message including the device ID of the wireless access point device 2 to the wireless terminal 4.

Alternatively, in Act A4, the control unit 11 determines that the access is not permitted. Then, via the No route, the control unit 11 executes the process of Act A3.

In Act A6, the wireless access point device 2 notifies the MFP 3 of the access made by the wireless terminal 4. The access point interface unit 47 generates interruption to the main CPU 6a.

In Act A7, the wireless access point device 2 activates a program task for generating a packet of the maintenance information.

This program reads the maintenance information from the second storage unit 75. The program adds the device ID of the wireless access point device 2 to the maintenance information. The program generates the packet including the maintenance information.

In Act A8, the wireless access point device 2 determines whether the information transmission request from the wireless terminal 4 is received. The control unit waits via the No route, while the information transmission request is not received.

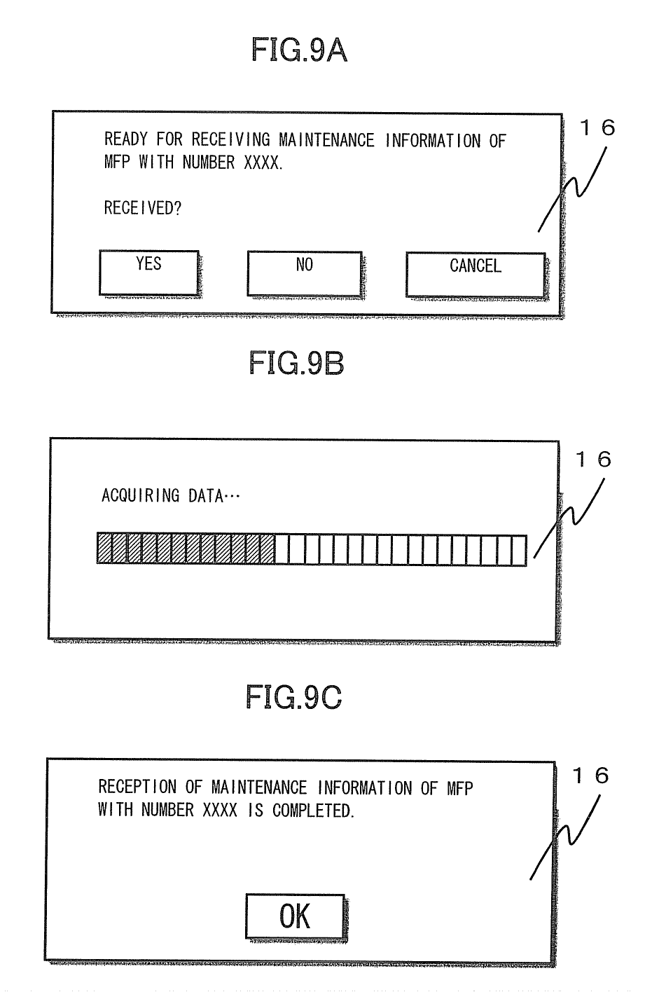

FIGS. 9A to 9C are diagrams illustrating other display examples of the wireless terminal 4.

As shown in FIG. 9A, the user operates the wireless terminal 4 to select the MFP 3 at the store 62. The wireless terminal 4 transmits the information transmission request for the maintenance information to the wireless access point device 2 of the MFP 3.

If the wireless access point device 2 receives the information transmission request in Act A8 of FIG. 6, the wireless access point device 2 wirelessly transmits the packet including the maintenance information in Act A9.

As shown in FIGS. 9B and 9C, the wireless terminal receives the packet. The maintenance staff member obtains the maintenance information from the desired MFP 3 on the display 15.

In Act A10 of FIG. 6, the wireless access point device 2 opens a wireless link. The wireless terminal 4 also opens a wireless link.

The transmitting of the maintenance information by the wireless access point device 2 and the MFP 3 ends.

The maintenance staff member also receives the maintenance information from the two other MFPs 3.

In this way, the wireless terminal 4 can directly receive the maintenance information from the plurality of MFPs 3. The maintenance staff member can obtain the maintenance information of the respective MFPs 3 within the area without having to move.

The maintenance staff member does not need to move to nearby the MFP 3 which are turned on among all the MFPs 3. The maintenance staff member is able to reduce burden of determining the state of the consumable goods and whether supplementing of the consumable goods is required.

(2) Next, an example of the method of acquiring the maintenance information by the wireless terminal 4 if the wireless access point device 2 is turned off will be described.

For example, on Friday evening, the recent use frequency information is written to the second storage unit 75 of the wireless access point device 2, immediately before the wireless access point device 2 is turned off.

On Saturday, the power source unit 22 of the MFP 3 is off. The power source 12 of the wireless access point device 2 is also off.

The maintenance staff member operates the wireless terminal 4 to transmit radio waves to the wireless access point device 2 from the outside of Building 5 or the room.

The wireless reception unit 8b of the wireless access point device 2 is intermittently activated. The wireless reception unit 8b receives the radio waves. Necessary circuits of the control unit 11 and the power source control unit 73 extract ID information from the received signal and authenticate the wireless terminal 4 based on the ID information.

The control unit 11 succeeds in the authentication. The power source control unit 73 activates the wireless access point device 2.

Thereafter, the wireless terminal 4 accesses to the wireless access point device 2 in the substantially similar way as that of the example of (1).

The wireless access point device 2 receives the link establishment request from the wireless terminal 4. The information transmission link is established by handshake.

The wireless terminal 4 wirelessly acquires the maintenance information directly from the wireless access point device 2. The acquisition of the information is completed. The wireless terminal 4 opens the wireless link.

The wireless access point device 2 also opens the wireless link. The power source control unit 73 of the wireless access point device 2 again turns off the power source 12.

On Saturday and Sunday, customers of the maintenance staff are on holiday. The MFP 3 is turned off. There are cases when the maintenance staff member needs to visit the office on a holiday to acquire the maintenance information.

The maintenance staff member can acquire the maintenance information from the MFP 3 which is turned off.

If the radio waves from the wireless terminal 4 are received, the wireless access point device 2 is activated. Only if the maintenance staff member desires to acquire the maintenance information, the wireless access point device 2 is operated. Therefore, security can be achieved.

At small-scale stores or small-scale business offices, the MFP 3 may not be connected to an outside network such as the Internet, a telephone line, or a dedicated network.

The MFP 3 has a wireless information publication system therein. The wireless access point device 2 wirelessly opens the maintenance information.

The maintenance staff member can acquire the maintenance information without having to visit the stores. The maintenance staff member does not need to go to the MFP 3 just to insert a USB memory. The MFP 3 reduces the work in which the maintenance staff member has to move.

The maintenance staff member does not need to maintain the MFPs 3 at each floor of a tall Building 5 with carrying equipment on. The number of maintenance staff members is limited. The work of each maintenance staff member is reduced. Accordingly, the maintenance efficiency of the MFPs 3 can be achieved.

The display 15 retains list information of all MFPs in the area for which they are responsible. The maintenance staff member can distinguish the MFPs 3 which are turned on from the MFPs 3 which are turned off.

The maintenance staff member can select the offices which the maintenance staff member has to visit, among the plurality of offices. The maintenance staff member can quickly visit the office at which the consumable goods of the MFP have to be exchanged. In addition, the maintenance staff member can skip the offices where visiting is not necessary.

The wireless access point device 2 switches the power of the wireless access point device 20N and OFF itself. The wireless access point device 2 reads the maintenance information from the MFP 3. The wireless access point device 2 stores the recent maintenance information.

If the wireless access point device 2 is turned on irrespective of whether the power source unit 22 of the MFP 3 is ON or OFF, the wireless access point device 2 can wirelessly transmit the maintenance information.

### Other Embodiments

The maintenance information may be transmitted from the first storage unit 7 to the second storage unit 75 at the periodic timing set in advance. The term periodic means a plurality of times or after a specific period. The timing is registered in advance in the ROM 6b.

The second storage unit 75 records a communication log of the maintenance information transmitted from the wireless access point device 2 to the wireless terminal 4.

The maintenance staff member refers to the communication log. Then, the maintenance staff member can detect improper access or erroneous transmission of the maintenance information. An administrator of the MFP 3 can grasp the details of the maintenance information transmitted in this case. The origin place of the information can be grasped and managed.

Since the communication log is recorded, the communication log can be transferred from the previous person in charge to the next person in charge. The communication log can be used as an index of the timing such as timing of supplement.

If the main CPU 6a turns off the wireless access point device 2 and then a sheet number counter value reaches a threshold value, the wireless access point device 2 may activate itself to begin the transmission of the radio waves.

The maintenance information is just an example, and the invention is not limited to the above-described example of the maintenance information. Although the details of the maintenance information may be changed and applied, the advantages of the image forming apparatus according to the embodiment is not lost.

The wireless terminal 4 may be a telephone instead of the personal computer 13.

As the image forming apparatus, a copy apparatus or a printer may be used.

The wireless interface function between the wireless access point device 2 and the wireless terminal 4 is realized by the wireless LAN. The function of the wireless transmission unit may be executed by various access methods or modulation methods.

In terms of the OSI (Open Systems Interconnection) layer model, the wireless access point has the function of terminating both the physical layer and the data link layer. The wireless access point uses a wireless link protocol layer in the data link layer.

The layer structure of the wireless access point has a layer which provides a service of a bridge function to an application in an upper layer of the wireless link protocol layer.

By using the wireless access point device 2 as the wireless transmission unit, the wireless access point device 2 can transmit a packet capable of realizing the bridge function. The wireless access point device 2 can carry out communication irrespective of the structure of the upper layer of the communication software of the wireless terminal 4.

While certain embodiments have been described, these embodiments have been presented by way of example only, and are not intended to limit the scope of the inventions. Indeed, the novel methods and systems described herein may be embodied in a variety of other forms; furthermore various omissions and substitutions and changes in the form of methods and systems described herein may be made without departing from the sprit of the inventions. The accompanying claims and their equivalents are intended to cover such forms or modifications as would fall within the scope and spirits of the inventions.

What is claimed is:

1. An image forming apparatus comprising:
a print processing unit configured to generate a developer image on a medium by an electrophotography;
a fixing unit configured to fix the developer image on the medium;
a first storage unit configured to store use frequency information of respective parts forming the print processing unit and the fixing unit and failure information of the image forming apparatus;
a wireless transmission unit configured to transmit wirelessly maintenance information including the use frequency information or the failure information; and
a controller configured to allow the wireless transmission unit to transmit the maintenance information to a wireless terminal positioning within an area to which the wireless transmission unit is operable to transmit a wireless signal.

2. The apparatus of claim 1, wherein the wireless transmission unit comprises:
a wireless reception unit configured to wirelessly receive a transmission request from the wireless terminal; and
a second storage unit configured to read the maintenance information from the first storage unit and store the read maintenance information,
wherein if the wireless reception unit receives the transmission request, the wireless transmission unit reads the maintenance information from the second storage unit.

3. The apparatus of claim 1, further comprising:
a first power source unit configured to turn on and off to supply first power to the image forming apparatus;
a second power source unit configured to turn on and off to supply second power to the wireless transmission unit; and
a power source controller configured to control the second power source unit,
wherein the power source controller controls ON and OFF of the second power source unit independently from the first power source unit.

4. The apparatus of claim 3, wherein the wireless transmission unit comprises:
a wireless reception unit configured to wirelessly receive a transmission request from the wireless terminal; and
a second storage unit configured to read the maintenance information from the first storage unit and stores the read maintenance information,
wherein if the wireless reception unit receives the transmission request, the wireless transmission unit reads the maintenance information from the second storage unit.

5. The apparatus of claim 1, further comprising:
a wireless reception unit wirelessly receiving a transmission request from the wireless terminal; and
a second power source unit which supplies or does not supply power to the wireless transmission unit;
wherein the controller turns on the second power source unit and transmits the maintenance information to the wireless transmission unit, if the controller turns off the second power source unit and then the wireless reception unit receives the transmission request.

6. The apparatus of claim 1,
wherein the first storage unit stores a threshold value, and
the controller compares the threshold value and the maintenance information to each other, and changes a state of the wireless transmission unit from an off-state to an on-state and transmits the maintenance information to the wireless transmission unit if the maintenance information exceeds the threshold value.

7. The apparatus of claim 1, wherein the wireless transmission unit configured to encode the wireless signal using a code used between the wireless transmission unit and the wireless terminal.

8. The apparatus of claim 1, further comprising:
an accumulation unit configured to accumulate a communication log of the wirelessly transmitted maintenance information.

9. The apparatus of claim 1, wherein the first storage unit stores failure occurrence information of the image forming apparatus, and the wireless transmission unit adds the failure occurrence information to the maintenance information.

10. The apparatus of claim 1, wherein the first storage unit stores consumable-goods identification information specifying a consumable member among members forming the image forming apparatus, and the wireless transmission unit adds the consumable-goods identification information to the maintenance information.

11. A method of acquiring maintenance information of an image forming apparatus, comprising:
accumulating, in a first storage unit, use frequency information of respective parts forming a print processing unit and a fixing unit and failure information of the image forming apparatus;
generating the maintenance information including the use frequency information and the failure information;
transmitting a wireless signal including the maintenance information from a wireless transmission unit; and
receiving the wireless signal to acquire the maintenance information.

12. The method of claim 11, further comprising:
before transmitting the maintenance information from the wireless transmission unit,
reading the maintenance information from the first storage unit and storing the maintenance information in a second storage unit by the wireless transmission unit, and generating the maintenance information from the second storage unit.

13. The method of claim 11, wherein the wireless transmission unit is turned on or off independently from a power source of the image forming apparatus.

14. The method of claim 13, further comprising:
before transmitting the maintenance information from the wireless transmission unit,
reading the maintenance information from the first storage unit and storing the maintenance information in a second storage unit by the wireless transmission unit, and generating the maintenance information from the second storage unit.

15. The method of claim 11, further comprising:
turning on the wireless transmission unit and transmitting the maintenance information to the wireless transmission unit, if the image forming apparatus is turned off and then the transmission request is wirelessly received.

16. The method of claim 11, further comprising:
comparing a threshold value set in advance and the maintenance information to each other; and
changing a state of the wireless transmission unit from an off-state to an on-state and transmitting the maintenance information to the wireless transmission unit, if the maintenance information exceeds the threshold value.

17. The method of claim 11, wherein the wireless signal is encoded using a code used between the wireless transmission unit and the wireless terminal.

18. The method of claim 11, wherein a communication log of the wirelessly transmitted maintenance information is accumulated.

19. A method of acquiring maintenance information of an image forming apparatus, comprising:
accumulating use frequency information of respective parts forming each print processing unit and each fixing unit of a plurality of the image forming apparatuses or failure information of the image forming apparatuses;
generating each of the plurality of maintenance information including the use frequency information and the failure information;
transmitting a wireless signal including each maintenance information from a wireless transmission unit; and
receiving each wireless signal to acquire each maintenance information.

20. The method of claim 19, wherein each image forming apparatus collects each maintenance information.
